(19) United States
(12) Patent Application Publication
(10) Pub. No.: US 2003/0201296 A1
(43) Pub. Date: Oct. 30, 2003

(54) Apparatus for fracturing connecting rod pre-forms

(76) Inventors: Sam Magliaro, Tecumseh (CA); Brian Taylor, Tecumseh (CA); Fernando Bayuga, Windsor (CA); Keiji Takeshima, Windsor (CA)

Correspondence Address: CARLSON, GASKEY & OLDS, P.C., 400 WEST MAPLE ROAD, SUITE 350, BIRMINGHAM, MI, 48009, US

(21) Appl. No.: 10/171,881

(22) Filed: Jun. 14, 2002

Related U.S. Application Data
(60) Provisional application No. 60/376,311, filed on Apr. 29, 2002.

(51) Int. Cl. B26F 3/00; B26F 3/02; B65H 35/00; B65H 35/10

(52) U.S. Cl. 225/1; 225/93; 225/103

(57) ABSTRACT

An apparatus for separation of a pre-form into a bearing cap and a connecting rod by fracturing the pre-form along a predetermined fracture line. The apparatus includes a split mandrel defining upper and lower parts sitting within a cylindrical aperture of the pre-form and defining an internal passageway within which a wedge moves to separate the mandrel halves. Separation of the mandrel halves by the wedge member causes fracture separation of the pre-form into a bearing cap and connecting rod. A bottom portion of the mandrel is adjustable in relation to the wedge member to provide for proper alignment of the wedge and mandrel during fracture separation of the connecting rod.

### RELATED APPLICATIONS

This application claims priority to U.S. Provisional Application Serial No. 60/376,311; filed on Apr. 29, 2002.

### BACKGROUND OF THE INVENTION

This invention relates to the fracture separation of a connecting rod pre-form into a connecting rod and bearing cap, while ensuring that the separated pieces are capable of reunification in a high volume production environment.

Numerous conventional methods have been employed to separate connecting rod pre-forms by fracturing both in laboratory and production environments. These methods include cryogenic cooling or electron beam exposure to embrittle the fractured area, and fracture separating by opposing pulling forces that separate the bearing cap from the connecting rod pre-form. Despite these developments, certain elements vital to fracture separation continue to present challenges to the quality of the finished connecting rod. One such challenge includes achieving a simultaneous fracture along the fracture plane of both legs of the connecting rod. Failure to achieve simultaneous fracture results in plastic deformation of the crank bore and inhibits satisfactory re-mating of the two parts. Fracturing both legs simultaneously requires precise alignment of the separating mechanism with the pre-form.

Another challenge includes maintaining positive control of the separated bearing cap relative to the connecting rod body to ensure accurate realignment following separation for high volume production applications. Failure to properly realign the fractured parts after separation eliminates the advantages inherent in a fracture separation manufacturing process.

Accordingly, it is desirable to develop a high speed production process for fracture separation of a pre-form to a bearing cap and connecting rod while ensuring that the separated pieces will be properly reassembled and aligned.

### SUMMARY OF THE INVENTION

A disclosed embodiment includes an apparatus for fracture separating a pre-form into a bearing cap and connecting rod using a dual slide ram coupled to a wedge driven between portions of an adjustable mandrel.

The process of this invention is conducted under ambient conditions and requires no prior embrittlement of the pre-form. A stress riser controls the location of fracture initiation. The stress riser includes a v-notch machined into the pre-form. It could also include a series of holes drilled by utilizing a laser beam. A work holding fixture retains and locates the connecting rod pre-form with respect to selected manufacturing datum and part features. The mechanism includes a dual slide ram coupled to a lateral wedge interposed between a two-pieced mandrel which when activated causes fracture separation of the pre-form to a bearing cap and connecting rod.

The work holding fixture locates the connecting rod pre-form on the manufacturing datums maintaining proper alignment during separation and re-mating. The work holding fixture is supported on a precision slide. A lower portion of the work holding fixture rigidly secures the connecting rod body to the slide and restrains the connecting rod against movement. The upper portion of the work holding fixture locates and retains the bearing cap with the connecting rod affixed to a saddle movable on the precision slide.

This arrangement allows the bearing cap to move independently of the connecting rod body during separation, while maintaining precision alignment relative to the connecting rod body. The arrangement of the present invention substantially reduces the tendency for the bearing cap to rotate during separation, thereby promoting simultaneous fracture of both the connecting rod legs. Springs biasing the bearing cap toward the connecting rod after separation accomplish re-mating of the separated bearing cap to the connecting rod.

An embodiment of this invention includes a base member, and a guide member fixed with respect to the base member. The guide member defines a first guideway extending in a first direction. A first slide member mounted to the guide member slides along the first guideway in the first direction. The first slide member also defines a second guideway also extending in the first direction. A second slide member mounted to the first slide member slides relative to the first slide member within the second guideway. A split mandrel includes an upper part fixed with respect to the first slide member and a lower part movable relative to the base and the wedge member, thereby facilitating proper alignment with the pre-form. Adjustment is accomplished by moving a tapered member laterally to raise or lower the mandrel relative to the wedge member. Movement of the tapered member horizontally lifts the lower part of the mandrel vertically for adjustment relative to the wedge member. The lower wedge member is also adjustable horizontally by proper sizing of a second spacer abutting a key disposed in a keyway within the base.

The wedge member enters a tapered passageway defined by the mandrel parts to spread the mandrel and force fracturing of the pre-form at the desired location. A power means drives the wedge member through the tapered passageway.

Another embodiment of this invention is a method for fracture separation of a pre-form into a bearing cap and connecting rod. The process includes the steps of feeding a cylindrical aperture of the pre-form over a substantially cylindrical mandrel including upper and lower parts. The method continues by holding the pre-form in place over the mandrel by pressing against the bolt seat shoulders over the pre-form in a direction towards the mandrel and forcing the mandrel apart by holding the pre-form in place and forcing a wedge member between the mandrel parts.

The apparatus and method of this invention provides consistent repeatable fracture separation of a pre-form into a bearing cap and connecting rod while maintaining proper realignment of the fractured halves in a high production-manufacturing environment.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a front view looking at the front of the separation station;

FIG. 2 is a side view of the separation station;

FIG. 3 is a front view of the pre-form and split mandrel;

FIG. 4 is a sectional view taken at the line 3-3 in FIG. 2 and line 3-3 in FIG. 1;

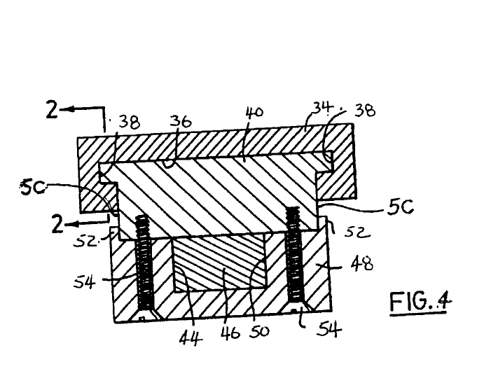

FIG. 5 is a schematic view of a high velocity ram for driving the wedge member; and

FIG. 6, is a schematic view of a drive configuration for driving the wedge.

### DETAILED DESCRIPTION OF THE PREFERRED EMBODIMENT

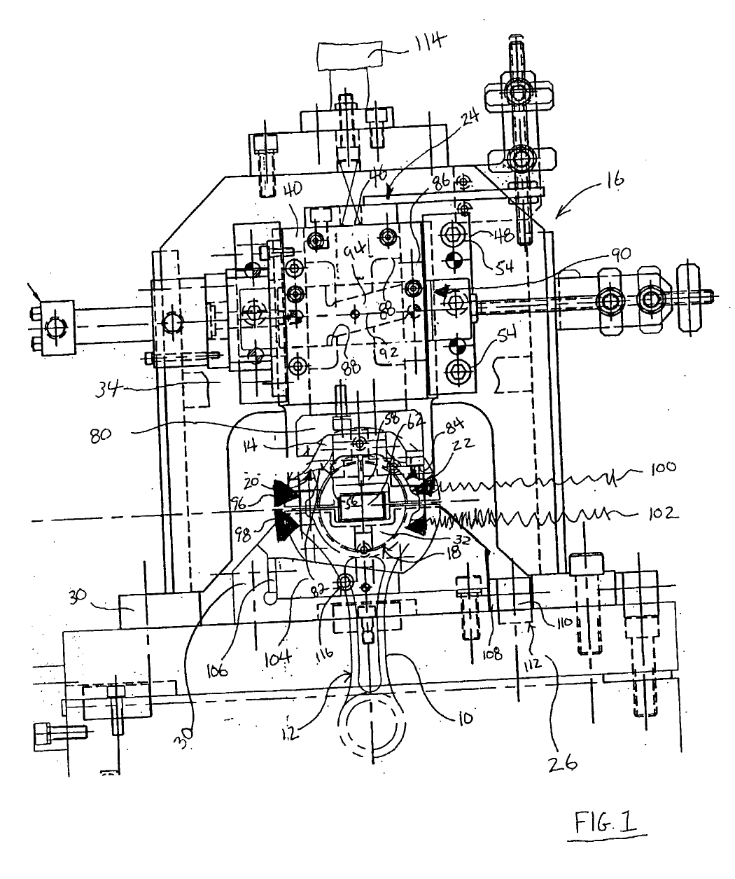

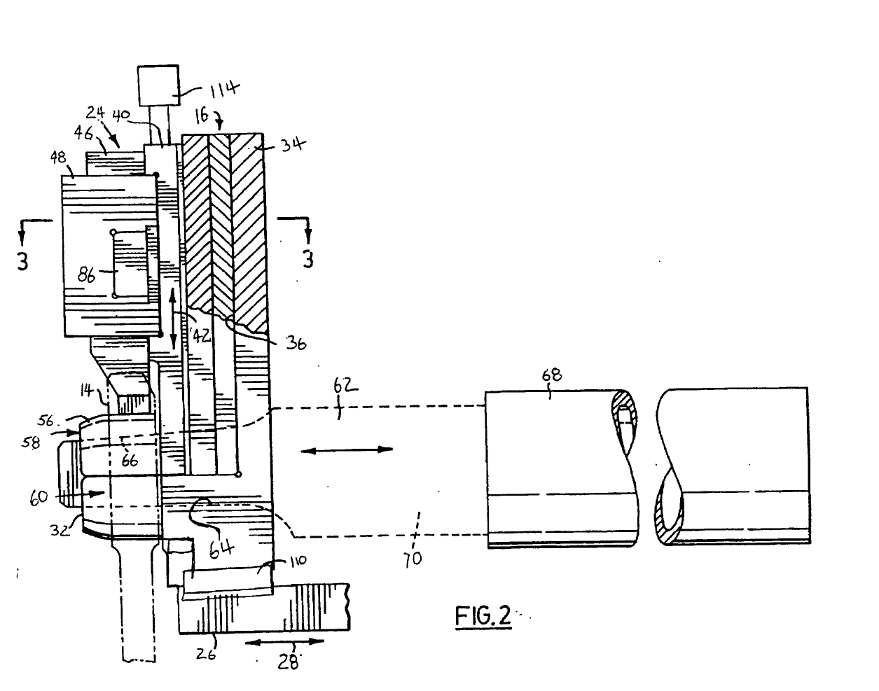

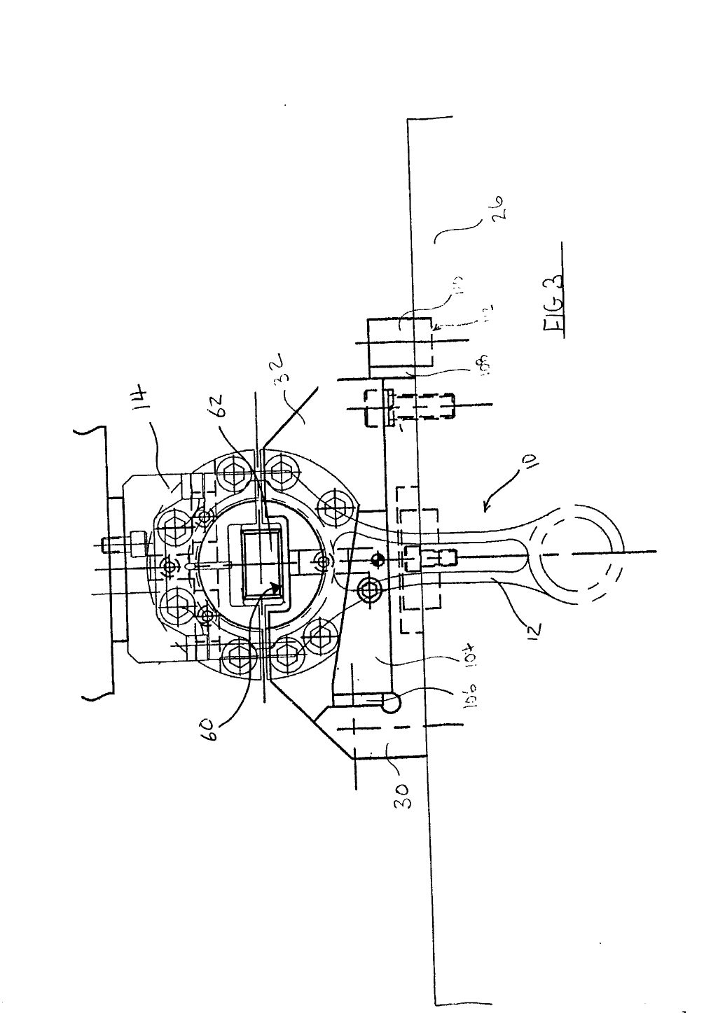

Referring to FIGS. 1, 2, and 3 a pre-separated pre-form 10 including a connecting rod 12 and a bearing cap 14 is located and secured in a separating station work holding fixture 16. The pre-form 10 is confined within a cylindrical aperture 18 and two spaced apart seat shoulders 20 and 22. A fixture 16 retains the bearing cap 14, both before and after fracturing. Retention of the bearing cap 14 is accomplished through the use of a small slide assembly 24 best shown in FIGS. 2 and 3.

A slide unit 26 is mounted for horizontal movement along the direction of arrow 28 (FIG. 2). Secured to the slide unit 26 is a base member 30 adjacent a lower part 32 of a split mandrel 58 and guide member 34. The guide member 34 defines a first guideway 36 that includes two oppositely extending rectangular recesses 38 (FIG. 3). The first guideway 36 extends in a direction perpendicular to the arrow 28. A first slide member 40 is mounted to the guide member 34 for sliding movement along the first guideway 36 in the vertical direction and itself contributes to defining a second guideway 44 parallel with the direction of the first guideway 36. A second slide member 46 comprises a rectangular section with an upper portion trapped between the first slide member 40 and a slide assembly cover 48. The cover 48 defines a rectangular recess 50 and has lateral connections 52 for securely locating the cover 48 on the first slide member 40. Threaded fasteners 54 are utilized to secure the cover 48 against the first slide member 40.

Referring to FIG. 2, the first slide member 40 integrally supports an upper part 56 of a split mandrel 58. When the first slide member 40 moves upwardly with respect to the guide member 34, the upper part 56 of the split mandrel 58 moves upwardly away from the lower part 32. The axis of the split mandrel 58 lies in a direction substantially parallel to the arrow 28 and is thus substantially perpendicular to the first guideway 36. The upper and lower parts 56 and 32 of the mandrel 58 together define an internal tapered passageway shown in broken lines at 60. The passageway 60 is configured such that a wedge member 62 driven through the passageway 60 forces the mandrel parts 56 and 32 apart. The passageway 60 has a substantially horizontal inner portion 64 and a sloping upper portion 66. A leftward edge of the wedge member 62 is correspondingly configured. The purpose of this configuration is to avoid downward force against the lower mandrel 32 and to maximize upward force against the upper part 56.

FIG. 3 is a schematic view of the fixture 16 with many parts removed to clearly show how the lower mandrel 32 is movable relative to the wedge member 62. The lower mandrel 32 moves relative to the wedge member 62 such that the tapered passageway 60 aligns with the wedge member 62. A tapered member 104 supports and adjusts the lower part of the mandrel 32. The tapered member 104 is disposed between the lower mandrel 32 and the base member 30. Lateral movement of the tapered member 104 lifts the lower mandrel 32 horizontally upward against the wedge member 62. Positioning of the lower mandrel 32 against the wedge member 62 prevents damage caused by improper alignment.

The tapered member 104 is moved horizontally to lift the lower part of the mandrel 32 upward against the wedge member 62. Once the lower mandrel 32 is aligned with the wedge member 62, a first spacer 106 is placed between the tapered member 104 and the base 30. The spacer 106 is sized to correspond with the position of the tapered member 104 after alignment. Further, alignment is possible by simply replacing the spacer 106 with a spacer of a different size. In addition, the aligned position of the tapered member 104 is secured by a threaded fastener 116. Alignment of the lower mandrel 32 is preferably accomplished during initial set-up of the machine. As appreciated, alignment of the lower mandrel 32 prevents bending of the wedge member 62 downwardly toward the base 30 that may potentially cause damage to the wedge member 62 and the mandrel 58.

Horizontal alignment of the lower part of the mandrel 32 is accomplished by way of a correspondingly sized second spacer 108 disposed against a key 110 within a keyway slot 112 machined within the base 30. The second spacer 108 is machined to the precise tolerances required to position the lower part of the mandrel 32 into alignment with the wedge member 62. Proper horizontal alignment of the lower mandrel 32 relative to the wedge member 62 also ensures that the mandrel 62 will exert a substantially upward force on the pre-form 10 during fracturing operations. Horizontal alignment of the lower mandrel 32 relative to the wedge member 62 substantially improves the uniform fracture separation of the bearing cap 14 from the connecting rod 12.

Referring to FIG. 2, the upper and lower parts 56, 32 of the mandrel 58 together define the internal tapered passageway 60. The passageway 60 accepts the wedge member 62 to force the mandrel parts 56 and 32 apart. The passageway 60 has a substantially horizontal lower portion 64 and a sloping upper portion 66. The purpose of this configuration is to avoid downward force on the lower part 32 and to maximize upward force against the upper part 56. Power means for moving the wedge member 62 is preferably a hydraulic or pneumatic cylinder 68. As appreciated, it is within the contemplation of this invention that the wedge member 62 be actuated by any such power means as known to one skilled in the art.

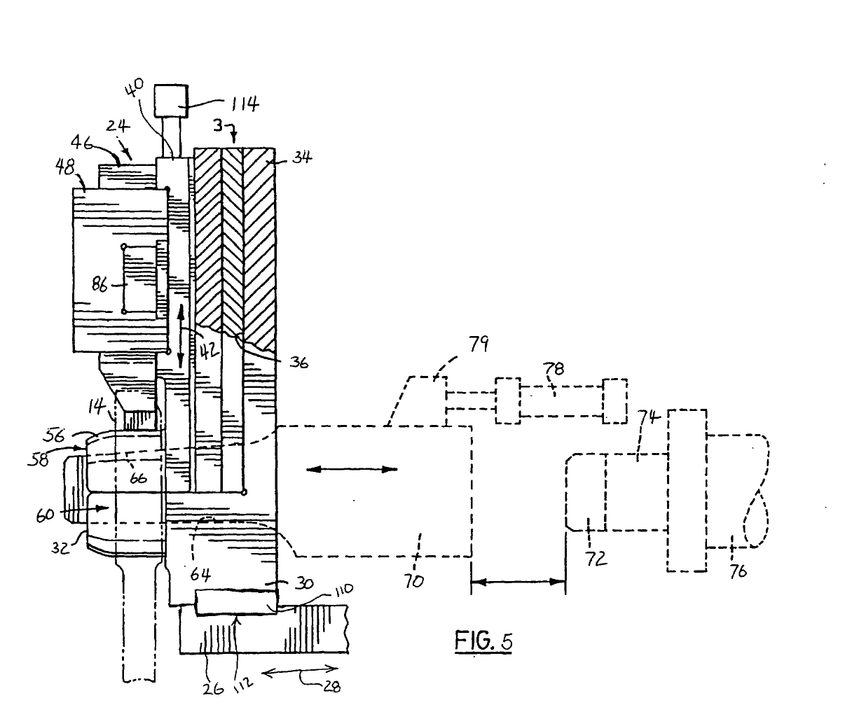

Referring to FIG. 5, a wedge member 70 first contacts the tapered passageway 60 at a low force level creating a pre-load upon the contact surfaces of the internal tapered passageway. A separate high velocity ram 72 then impacts the wedge member 70 to cause separation of the pre-form into the bearing cap 14 and connecting rod 12. The preload of the wedge member 70 takes up slack, leaving no free travel or lost motion in the upper and lower parts 58 and 32 defining the tapered passageway 60. The ram 72 is the end of a piston 74 moving in a cylinder 76. The position of the wedge member 70 is controlled by an auxiliary cylinder 78 schematically illustrated on a flange 79 secured to the wedge member 70.

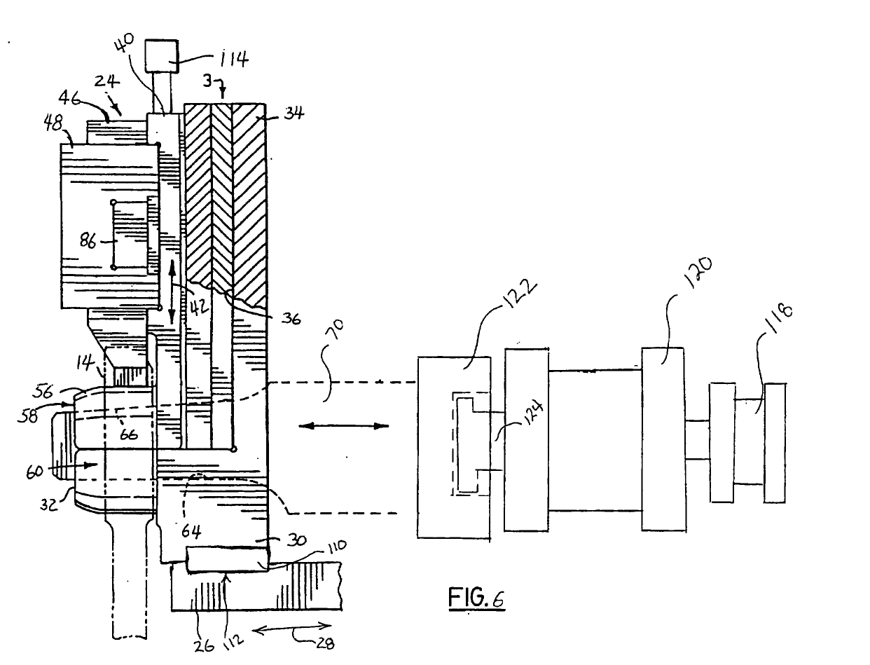

Referring to FIG. 6, the wedge member 70 is forced further into the internal passageway to cause separation of the pre-form 10 into the bearing cap 14 and connecting rod 12 by a larger hydraulic cylinder that is fixed to the wedge member 70 because the larger hydraulic cylinder is fixed to the wedge member 70 there is no impact on the wedge member 70. In this embodiment a positioning cylinder 118, moves the wedge 70 member into a preload condition within the tapered passage 60. A coupling 122 couples a shaft 124 of a drive cylinder 120 to the wedge member 70. There is no impact on the wedge member 70 as in the previous embodiment. The drive cylinder 120 actuates with the required force and speed to effect fracture separation of the pre-form 10.

Elimination of impact on the wedge member 70 provides consistency and control in specific applications were conditions dictate a greater degree of force control during the fracturing process. It should be understood that it is within the contemplation of this invention to use any type of device known by a worker skilled in the art to impart force of sufficient magnitude on the wedge member 70 to separate the pre-form 10 into the bearing cap 14 and connecting rod 12.

Referring to FIGS. 1 and 2, the second slide member 46 has a widened portion 80 supporting projections 82 and 84 which are adapted to contact the bolt seat shoulders 20 and 22 while the cylindrical aperture 18 in the pre-form 10 receives the split mandrel 58. A cam member 86 selectively urges the second slide member 46 toward the mandrel 70 and securely holds the integral pre-form 10 in place. The wedge member 70 enters the tapered passageway 60 and forces the upper mandrel part 56 upwardly away from the lower mandrel part 32 thereby fracturing the pre-form 10 into the bearing cap 14 and connecting rod 12.

The cover 48 defines a horizontal rectangular passage 88 to either side of the recess 50. The camming member 86 is a z-shaped cam adapted to be moved by a force along the arrow 90. The upper part of the second slide member 46 is machined to define a slipping passageway 40 for receiving a central part 94 of the cam 86 having the same slope as a passageway 92. As the camming member 86 moves leftward (as seen in FIG. 1), the second slide member 46 will move downwardly.

The retention locators 14-17 are illustrated schematically in FIG. 1. The locators 96 and 98 are fixed and the retainers 100 and 102 are movable to exert a constant force leftwardly on the pre-form 10 seating it firmly against the locators 96 and 98. The locators 96, 98, 100 and 102 include a first static locator 96 adapted to contact one side of the portion of the pre-form 10 which is intended to become the bearing cap 14 and a second static locator 98 adapted to contact one side of the portion of the pre-form 10 intended to become the connecting rod 12. On the right in FIG. 1, the dynamic locator 100 is adapted to contact the other side of the portion of the pre-form 10 which is intended to become the bearing cap 14 while the second dynamic locator 102 is adapted to contact the other side of the portion of the pre-form 10 which is intended to become the connecting rod 12. The dynamic locators 100 and 102 can be urged leftwardly by the use of resilient means such as springs. The locators 96 and 100 are mounted on the first slide member 40 while the locators 98 and 102 are mounted on the base member 30.

This invention includes a process for the fracture separation of the pre-form 10 into the bearing cap 14 and a connecting rod 12. The process involves force fitting the cylindrical aperture 18 of the pre-form 10 over the substantially cylindrical mandrel 58 that includes separate upper and lower parts 56 and 32. Holding the pre-form 10 in place on the mandrel 58 causes projections 82 and 84 to press downwardly against the bolt seat shoulders 20 and 22 in the directions toward the mandrel 58. The process continues by forcing the wedge member 62 between the mandrel halves 56 and 32. The first slide member 40 with its integral part 56 of the split mandrel 58 along with the cover 48 and the second slide member 46 move upward in response to the wedge member 62 being forced therebetween. The lower part 32 of the mandrel 58, the guide member 34 and the base member 30 of the slide unit 26 all remain stationary relative to the wedge member 62 as the wedge member 62 is forced through the mandrel 58.

Upon completion of fracture separation of the pre-form 10 the wedge member 62 is withdrawn from the mandrel halves 58 and 32 allowing the first slide member 40 to return to its pre-separation position. Removal of the wedge member returns the first slide member 40 downward employing a linear force device such as springs with the slide shown schematically at 114. After fracture separation of the pre-form 10 the bearing cap 14 is re-mated with the connecting rod portion 12 by being forced downwardly by the linear force device 114.

In operation, the work holding fixture 16 functions to perform fracture separation of the pre-form 10 by first gripping and locating the pre-form 10 by the locators 96 through 102 in the desired position. The second slide member 46 withdrawals upwardly such that the projections 82 and 84 do not interfere. The pre-form aperture 18 engages the split mandrel 58. Retention of the connecting rod 12 and bearing cap 14 is activated between the split mandrel 58 and the projections 82 and 84 that contact the bolt seat shoulders 20 and 22. The wedge member 70 is then driven into the tapered passageway 60 to drive the upper mandrel 58 upwardly away from the lower mandrel 32. After fracture separation, the wedge member 70 is withdrawn from the tapered passageway 60. The bearing cap retention constituted by the projections 82 and 84 is then disengaged. The split mandrel 58 and the ram slide assembly is disengaged from the connecting rod by moving the slide unit 26. The locators 96 through 102 are disengaged from the pre-form 10 and bolts are used to secure the bearing cap 14 to the connecting rod 12.

While this invention has been described and illustrated with the connecting rod pre-form 10 in a vertical attitude. The particular part attitude is not a limitation of this invention. The process and apparatus can be carried out with the connecting rod in any desired attitude. As appreciated, various slide actuators and clamps would thereby then be placed in similar attitudes relative to each other but only changing in direction.

The foregoing description exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. An apparatus for separation of an integral pre-form into a bearing cap and a connecting rod having a cylindrical aperture and two spaced apart bolt seat shoulders, the apparatus comprising:
a base member;
a guide member fixed with respect to said base member, said guide member defining a first guideway extending in a first direction;
a first slide member having lateral edges mounted to said guide member for sliding movement in said first guideway in said first direction, said first slide member defining a second guideway also extending in said first direction intermediate said lateral edges of said first slide member;
a second slide member mounted to said first slide member for sliding movement with respect to said first slide member in said second guideway in said first direction;
a mandrel which is split to define a cap part fixed with respect to said first slide member and a body part adjustable with respect to said base member, said cap part being movable between a first position spaced away from said body part and a second position disposed adjacent said body part to define a substantially cylindrical body having an axis lying substantially in a second direction perpendicular to said first direction, movement of said cap part being simultaneous with movement of said first slide member along said first guideway with respect to said guide member, said cap and body parts of said mandrel defining an internal tapered passageway;
a wedge member movable into said tapered passageway when said cap part is in said second position to force said mandrel parts apart;
a power drive for moving said wedge member;
said second slide member including a first and a second hold down portion mechanically connected such that said hold down portions move dependant upon each other, said second slide member operable to bring said first and said second hold down portion into contact with the bolt seat shoulders on the integral pre-form when the cylindrical aperture thereof receives said split mandrel;
a structure urging said second slide member toward said mandrel, thereby securely holding the integral pre-form in place; and
movement of said wedge member through said tapered passageway forcing said mandrel parts apart and fracturing said pre-form into the bearing cap and the connecting rod.

2. The apparatus as recited in claim 1, wherein said first and second hold down portions move as an integral one-piece part.

3. The apparatus as recited in claim 2, wherein said second slide member includes a connecting portion integrally connecting said first and second hold down portions, said structure urging said connecting portion.

4. The apparatus as recited in claim 1, wherein said structure includes a cam surface forcing said first and second hold down portions toward said mandrel.

5. An apparatus as recited in claim 4, wherein said structure includes a member which slides in a direction generally transverse to movement of said first and second hold down portions, and said cam surface urging said first and second hold down portions toward said mandrel.

6. The apparatus as recited in claim 1, including a tapered spacer for adjusting a position of said body portion of said mandrel relative to said wedge member.

7. The apparatus as recited in claim 6, wherein said tapered spacer moves horizontally to adjust said body portion of said mandrel vertically.

8. The apparatus as recited in claim 7 including a mounting spacer disposed between said base and said tapered spacer for maintaining proper alignment of said tapered spacer relative to said body portion of said mandrel.

9. The apparatus as recited in claim 1, further including a second spacer disposed between said body portion of said mandrel and a key disposed within a keyway within said base, said second spacer including a width adjustable for aligning said body portion of said mandrel with said wedge member.

10. An apparatus for separation of a pre-form into a bearing cap and a connecting rod having a cylindrical aperture, said apparatus comprising:
a mandrel including a first mandrel part and a second mandrel part defining a passageway therebetween, said first mandrel part adjustable for aligning said passageway with a wedge;
a mandrel slide having lateral edges integrally formed with said second mandrel part;
said second mandrel part being movable between a first position spaced away from said first mandrel part and a second position disposed adjacent said first mandrel part to define a substantially cylindrical body; and
a wedge selectively entering said passageway to force said first mandrel part and said second mandrel part apart in said first direction.

11. The apparatus of claim 10, further including a tapered member partially supporting said first mandrel part, said tapered member movable laterally relative to said first mandrel and including a tapered surface such that lateral movement moves said first mandrel part vertically.

12. The apparatus of claim 10, including a base partially supporting said first mandrel part, said base including a key way slot spaced apart from said first mandrel, a key disposed within said key way slot and a spacer disposed between said key and said first mandrel, said spacer sized to fix said first mandrel part relative to said wedge.

13. A process for the fracture separation, into a bearing cap and a connecting rod, of an integral pre-form which is configured to define a cylindrical aperture and two spaced-apart bolt seat shoulders, the process comprising;
a) adjusting a lower mandrel part relative to an upper mandrel part to define an internal tapered passageway;
b) fitting the cylindrical aperture of the pre-form over the cylindrical mandrel parts,
c) holding the pre-form in place over the mandrel by pressing against the bolt seat shoulders in the direction toward the mandrel, and
d) forcing the mandrel parts apart while holding the pre-form in place, thereby to fracture the pre-form into a bearing cap and a connecting rod.

14. The process claimed in claim 13, in which step c. is performed by forcing a wedge member into said passageway.

15. The process claimed in claim 13, in which step a) further includes the step of aligning the lower mandrel part relative to the wedge member.

16. The process claimed in claim 15, including the steps of moving a tapered member to vertically align the lower mandrel part and fixing said tapered member with a spacer inserted between said tapered member and a base portion.

17. The process claimed in claim 15, including the step of moving the lower mandrel horizontally relative to a base portion including a key disposed within a keyway and fixing said lower mandrel relative to said key way by installing a spacer between the lower mandrel and the key.

18. The process claimed in claim 13, in which said upper part of the mandrel is fixed with respect to a first slide member guided in a guideway fixed with respect to the lower part of the mandrel, such that when the parts are forced apart the first slide moves along said guideway.

19. The process claimed in claim 13, in which step c. further includes using a pinching action between a static locator and a dynamic locator on either side of the portion of the pre-form intended to become the bearing cap, and a pinching action between a further static locator and a further dynamic locator on either side of the portion of the pre-form intended to become the connecting rod.

20. The process claimed in claim 13, in which said upper part of the mandrel is fixed with respect to a first slide member guided in a guideway fixed with respect to the lower part of the mandrel, such that when the parts are forced apart the first slide member moves along said guideway.

21. The process claimed in claim 20 in which step c) further includes using a pinching action between a static locator and a dynamic locator on either side of the portion of the pre-form intended to become the bearing cap, and a pinching action between a further static locator and a further dynamic locator on either side of the portion of the pre-form intended to become the connecting rod.

22. The process claimed in 21 in which step b) is carried out by urging, against the bold seat shoulders, spaced-apart projections on a second slide member movable in a further guideway provided on the first slide member substantially parallel with said first guideway, said urging being accomplished by a cam means.
